(19) United States
(12) Patent Application Publication
(10) Pub. No.: US 2023/0390788 A1
(43) Pub. Date: Dec. 7, 2023

(54) SEPARATOR

(71) Applicant: GEA WESTFALIA SEPARATOR GROUP GMBH, Oelde (DE)

(72) Inventors: Andreas HÖLSCHER, Ennigerloh (DE); Andrej MICHEL, Ennigerloh (DE); Angelika VOLTMANN, Rheda-Wiedenbrück (DE); Kathrin QUITER, Drensteinfurt (DE); Thomas BATHELT, Oelde (DE); Thomas KLEIMANN, Oelde (DE)

(21) Appl. No.: 18/034,162

(22) PCT Filed: Oct. 28, 2021
(86) PCT No.: PCT/EP2021/079934

§ 371 Date: Apr. 27, 2023

(30) Foreign Application Priority Data
Nov. 2, 2020 (DE) 10 2020 128 748.8

(51) Int. Cl. B04B 1/14; B04B 11/04

(52) U.S. Cl. CPC B04B 1/14; B04B 11/04

(57) ABSTRACT

A self-draining separator for centrifugal separation of a suspension into a light liquid phase, a heavy solid phase, and a moderately heavy intermediate phase. The separator includes a rotatable centrifuging drum, a liquid discharge for the light liquid phase, a discontinuously active solid matter discharge opening for the heavy solid phase, to which a first actuatable discharge device is assigned, by way of which the solid matter discharge opening can be discontinuously opened and closed. The separator also includes a discontinuously active discharge opening for the intermediate phase, to which at least one second actuatable discharge device is assigned, by way of which the discharge opening for the intermediate phase can be discontinuously opened and closed again. The second discontinuously active discharge device can be actuated independently of the first discontinuously active discharge device, with the result that the discharge of the intermediate phase can take place temporally independently of the discharge of the solid phase.

### BACKGROUND AND SUMMARY OF THE INVENTION

Exemplary embodiments of the invention relate to a self-draining separator for centrifugal separation of a suspension S into at least a light liquid phase LP, a heavy solid phase SP and a moderately heavy intermediate phase IP, which has a centrifuging drum rotatable about a rotational axis D.

In addition to one or more continuous outlets for one or more liquid phases, discontinuous self-draining separators of the type have a discharge system with a piston slide valve which, actuated by fluid, in particular with liquid as fluid, can be moved alternately into an open position and into a closed position, whereby the piston slide valve opens (open position) and closes (closed position) one or more solid matter discharge openings in the drum wall. In the open position, a solid phase is ejected from the centrifuging drum and thus discharged from the drum. In the closed position, the solid matter discharge openings are closed so that this is not possible.

To ensure precise operation of such a drum draining system with a piston slide valve, the latter can have a fluid supply and drainage system for controlling the movement of the piston slide valve into the closed position and the open position. This in turn may be provided with one or more valves. The valve or valves serve to fill a control chamber on the piston slide valve with fluid—a liquid or a gas—and it serves to drain fluid from a chamber on the piston slide valve for a discharge of solids, so that the piston slide valve can move to another position. For example, in a separator having a vertical rotational axis, fluid can escape below a piston slide valve so that the product in the drum pushes the piston slide valve vertically downward after the fluid is discharged. The valve for filling the control chamber is also called the control water valve, while the valve for draining the control chamber is also called the piston valve due to its preferred design.

DE 26 09 663 discloses a separator having a drum in which the separated heavy phase (concentrate) is discharged directly from the solids space via individual peripherally distributed piston valves. The piston valves are controlled, i.e., closed or opened, via a common ring valve.

In centrifugal processing of a product in three phases, an incoming suspension is separated in the drum into a lighter or less dense liquid phase, a generally still flowable moderately heavy or moderately dense intermediate phase, and a heavier (optionally also still flowable) or denser solid phase.

According to the prior art, the intermediate phase is discharged, for example, via a further continuous liquid discharge such as a peeling disc or the like. Alternatively, the intermediate phase can be discharged together with the solids during draining.

EP 2 348 894 B2, for example, discloses a separator having a drum, in which the light phase is discharged via a gripper or a peeling disc, wherein the heavier solid phase is discharged by means of a piston slide valve, and the intermediate phase is discharged via a separating disc and a further gripper or a further peeling disc. However, the intermediate phase is discharged continuously in this case. If necessary, the discharge of the intermediate phase is recirculated into the inlet.

A major problem of prior art solutions is that the intermediate phase is only discharged continuously and often cannot be discharged without loss or with low loss. In this context, loss-free means that the discharged intermediate phase does not contain any portion of the light and/or the heavy phase. In this context, low-loss means that the discharged intermediate phase contains only a small proportion of the light and/or heavy phase.

Exemplary embodiments of the invention is to solve this problem.

A self-draining separator for centrifugally separating a suspension S into at least a light liquid phase LP, a heavy solid phase SP, and a moderately heavy intermediate phase IP, comprises at least the following:
a) a centrifuging drum, which is rotatable about a rotational axis and into which the suspension S to be processed can be introduced,
b) at least one liquid discharge for the light liquid phase LP,
c) at least one or more discontinuously acting solid matter discharge opening(s) for the heavy solid phase SP, to which at least one first actuatable discharge device is assigned, by means of which the at least one or more solid matter discharge opening(s) can be opened discontinuously and closed again, and
d) at least one or more discontinuously acting discharge opening(s) for the intermediate phase IP, to which at least one second actuatable discharge device is assigned, by means of which the at least one or more discharge opening(s) for the intermediate phase IP can be opened discontinuously and closed again,
e) wherein the second discharge device can be actuated independently of the first discharge device, so that the discharge of the intermediate phase IP can take place temporally independently of the discharge of the solid phase SP.

Thus, the second discharge device can be controlled independently of the first discharge device, so that the discharge of the intermediate phase IP is decoupled from the discharge of the solid phase SP. With the two independently actuatable or “operating” discharge devices, it is advantageously possible to discharge the solid phase and the intermediate phase at precisely the time and to precisely the extent required for centrifugal separation. Thus, in the test, one or more sensors can be used to determine in advance from the behavior of the drum when which phase is to be discharged and for how long. This measurement is stored. Then, during operation, the appropriate time and duration for discharging the respective phase can be determined by comparison with these measurements. All this can be controlled by a control device. In particular, the intermediate phase can also be discharged in a defined manner and without loss or with low loss by the second discharge device.

It should be noted that the light phase is the least dense phase, the moderately heavy phase is a phase with a relatively greater density, and the heavy phase is one with an even greater density.

According to a first, preferred embodiment variant of the invention,
the first discharge device comprises at least one fluidically, in particular hydraulically, or electrically (in particular electromechanically or electromagnetically) actuatable, mechanically acting opening and closing means, with which the at least one or more solid matter discharge opening(s) can be opened and closed, and
the second discharge device comprises at least one fluidically, in particular hydraulically, or electrically actuatable, mechanically acting opening and closing means with which the at least one or more discharge opening(s) for the intermediate phase IP can be opened and closed.

This design is constructively simple to implement in various ways, which is explained below by way of example.

Thus, according to a preferred embodiment variant of the invention, it can be advantageously provided that the mechanically acting opening and closing means of the first discharge device is a piston slide valve arranged in or on the outside of the centrifuging drum, in particular hydraulically actuatable, which can be moved into different positions in order to open the one or more solid matter discharge openings in an open position or to close them in a closed position.

However, it can also be advantageously provided in another preferred embodiment variant of the invention that the mechanically acting opening and closing means of the first discharge device has at least one or more electrically or fluidically actuatable valves, in particular piston valves, which are assigned to the respective solid matter discharge opening or openings in order to open them or close them in a closed position.

It can further be provided that the mechanically acting opening and closing means of the second discharge device is a piston slide valve arranged on the outside of the centrifuging drum and in particular hydraulically actuatable, which can be moved into different positions in order to open the one or more discharge openings for the intermediate phase IP in an open position or to close them in a closed position, or it can be provided that the mechanically acting opening and closing means of the second discharge device comprises at least one or more electrically or fluidically actuatable valves, in particular piston valves, which are assigned to the respective discharge opening or openings for the intermediate phase IP in order to open them or to close them in a closed position.

The following variants are particularly preferred, as they are easy to implement in terms of design and simple to operate with low losses:

According to a preferred design, the mechanically acting opening and closing means of the first discharge device is a piston slide valve arranged in the centrifuging drum, in particular one that can be actuated hydraulically, and the mechanically acting opening and closing means of the second discharge device is a further piston slide valve arranged on the outside of the centrifuging drum, in particular one that can be controlled hydraulically.

According to another preferred design, the mechanically acting opening and closing means of the first discharge device is a piston slide valve arranged in the centrifuging drum, in particular a hydraulically actuatable piston slide valve, and the mechanically acting opening and closing means of the second discharge device is at least one actuatable piston valve which is assigned to the respective discharge openings for the intermediate phase IP in order to open them or to close them in a closed position.

According to a third preferred design, the mechanically acting opening and closing means of the first discharge device comprises actuatable piston valves that are associated with the respective solid matter discharge openings in order to open them or to close them in a closed position, and the mechanically acting opening and closing means of the second discharge device comprises actuatable piston valves that are associated with the respective discharge openings for the intermediate phase IP in order to open them or to close them in a closed position.

Other advantageous designs and combinations of a piston slide valve and piston valves are conceivable.

It can also be provided that spigot-like tubes are placed on or in the discharge openings for the intermediate phase IP, the length of which is such that they extend radially up to a radius R3 into a layer of the intermediate phase IP that forms radially in the centrifuging drum during rotation thereof, so that the discharge of the intermediate phase IP from the centrifuging drum takes place on the radius R3.

It is provided that radius R3 is smaller than radius R2, on which the solid matter discharge openings are arranged, but larger than radius R1, on which the liquid phase LP is discharged. This advantageously results in a defined discharge of the respective phase in which mixing with the other phases is largely excluded.

In a further embodiment variant of the invention, a peeling disc may be assigned to the liquid discharge. However, the liquid discharge can also be implemented in other ways.

In a further embodiment of the invention, the discharged solid phase SP is ejected through the at least one solid matter discharge opening into a first annular space as a solids trap, which is arranged in a hood-like housing and has a nozzle arranged radially on the first annular space for connection of a hose or a line for further discharge of the solid phase SP. As a result, the solid phase SP can be discharged in a simple design and thus advantageously independently of the intermediate phase IP.

In a further embodiment of the invention, the discharged intermediate phase IP passes through the at least one discharge opening into a further annular space, which is arranged in the hood-like housing and has a nozzle arranged radially on the further annular space for connection of a hose or a line for further discharge of the intermediate phase IP. As a result, the intermediate phase IP can be discharged in a structurally simple manner and thus advantageously independently of the solid phase SP.

### BRIEF DESCRIPTION OF THE DRAWING FIGURES

The invention is described in more detail below by means of exemplary embodiments with reference to the drawing. The invention is not limited to these exemplary embodiments, but can also be realized in other ways according to the wording or in other equivalent ways, wherein:

FIGS. 1-3 each show sectional views of different variants of separators, each with a centrifuging drum and with components of a discharge mechanism of the centrifuging drum for a solid phase and for an intermediate phase.

### DETAILED DESCRIPTION

In the following description of figures, three exemplary embodiments are described. The individual features of these exemplary embodiments may also be combined with exemplary embodiments not shown and are also each suitable as advantageous designs of the objects described in one or more of the main claims and subclaims.

Terms such as “above”, “below”, “right”, “left”, “outside” or “inside” refer to the respective position shown in the figures.

The individual features of the following exemplary embodiments may be combined as shown, or in other ways not shown, such as to form other exemplary embodiments not shown.

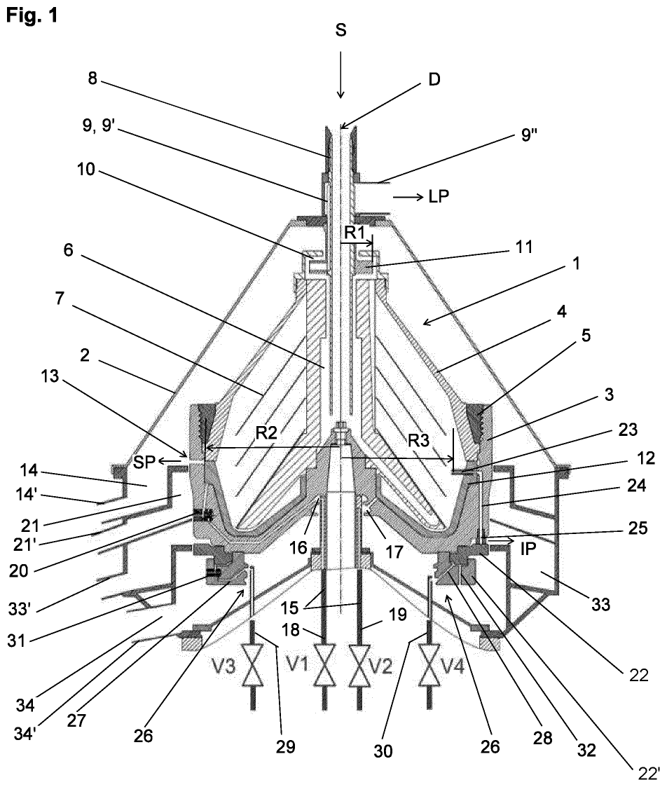

FIG. 1 shows a first separator having a rotatable centrifuging drum 1. The centrifuging drum 1 may have a vertical rotational axis D. The centrifuging drum 1 may be enclosed by a hood-like housing 2 that is not moved during operation of the centrifuge, i.e., is stationary. Further components such as a rotary drive or a control device are not shown.

The centrifuging drum 1 can preferably be of single and/or, as here, double conical design (at the bottom and/or top and, in particular, on the inside). This shape favors the collection of the separated solid phase in a defined area of the drum. The centrifuging drum 1 is preferably designed for continuous operation, in which a continuously feeding suspension S is continuously centrifugally processed and separated into a light liquid phase LP, a moderately heavy intermediate phase IP and a heavy solid phase SP.

The centrifuging drum 1 may have a lower drum part 3 and an upper drum part 4. These drum parts 3, 4 can each be of conical design on the outside and/or inside and can be connected to each other in various ways, such as with a locking ring 5.

An inlet pipe 8 is used to feed a suspension S to be processed into the centrifuging drum 1.

The inlet pipe 8 can be designed as a stationary element that does not rotate during operation, as shown here. However, it can also be designed to rotate. Here, it extends concentrically to the rotational axis D into the centrifuging drum 1. In addition, it extends through the housing 2 above the centrifuging drum 1.

A distributor 6 for feeding product into the drum and a disc pack 7 of separator discs may be arranged in the centrifuging drum 1. The separator discs 7 can be arranged on a distributor shaft of the distributor 6.

According to FIGS. 1 to 3, in a preferred—but not mandatory—design, the inlet pipe 8 extends into the centrifuging drum 1 from above, but it can also extend into the centrifuging drum 1 from below (not shown).

The centrifuging drum 1 has a liquid discharge 9 through which the light liquid phase LP can be conducted out of the drum 1. The liquid discharge 9 is realized here by a peeling disc 11. However, it can be designed in other ways.

The liquid discharge 9 opens internally into an annular space 9′, which in turn can open into a radial nozzle 9″ provided for a connection of a hose or line for discharging the liquid phase LP.

The light liquid phase LP draining radially inwardly from the disc pack 7 flows into a peeling disc chamber 10, which rotates with the centrifuging drum 1. A peeling disc 11 is arranged in the peeling disc chamber 10. This peeling disc 11 is not rotatable in the peeling disc chamber 10, i.e., it is arranged stationary. By means of the peeling disc 11—also referred to as a gripper—which operates as a centripetal pump, the liquid phase LP is discharged from the centrifugal field forming in the centrifuging drum 1 in operation on a radius R1 and is guided or conducted out of the centrifuging drum 1 via the liquid discharge 9, the annular space 9′ and the nozzle 9″. The discharge of the liquid phase LP thus takes place continuously.

For the discharge of a heavy solid phase SP, a fluidically and/or electrically—here fluidically—actuatable as well as mechanically acting opening and closing means is provided, which is designed here as an—inner—piston slide valve 12 arranged in the centrifuging drum 1.

The inner piston slide valve 12 is provided for opening and closing at least one solid matter discharge opening 13. Preferably, several of the solid matter discharge openings 13 can be formed circumferentially distributed in the area of the largest diameter—on a radius R2—of the centrifuging drum 1. Through the solid matter discharge openings 13, the discharged solid phase SP passes into a first solids-trap-like annular space 14, which is arranged in the housing 2 and can have a nozzle 14′, arranged radially on the first annular space 14, for connection of a hose or a line for further discharge of the solid phase SP.

A first discharge device 15 is provided for discharging the solid phase SP, which comprises a mechanically acting opening and closing means that can be fluidically actuated by actuators to perform opening and closing movements.

For this purpose, the first discharge device 15 can comprise an injection chamber 16 for opening fluid and an injection chamber 17 for closing fluid, to which a fluid, in particular water, can be supplied for activating the opening and closing movements of the internal piston slide valve 12 via an opening fluid supply line 18 and a closing fluid supply line 19, in which a first opening fluid valve V1 and a first closing fluid valve V2 are arranged.

The closing process of the solid matter discharge openings 13, i.e., in this case a lifting of the inner piston slide valve 12, can be effected by closing fluid that is injected into a chamber below the inner piston slide valve 12. The closing fluid is metered via the closing fluid valve V2. The chamber is in communication with piston valves 20, which are arranged in the wall of the centrifuging drum 1 in such a way that they can be closed by the centrifugal force prevailing in the centrifuging drum 1 in operation.

The opening process of the solid matter discharge openings 13, i.e., the lowering of the inner piston slide valve 12, is carried out by opening fluid that opens the piston valves 20, which in turn allows the closing fluid under the inner piston slide valve 12 to escape from the chamber. For this purpose, a small amount of opening fluid is briefly fed through a supply line via an opening fluid injection chamber 16 into connecting lines in the lower drum part 3. The opening fluid ensures a build-up of fluid pressure on all sides, which moves a closing piston against the centrifugal force in radial direction to the rotational axis D and thus opens the piston valve 20 of the centrifuging drum 1.

The opening fluid is metered via the opening fluid valve V1.

The closing fluid escapes through the opened piston valves 20 into a second annular space 21, which is arranged in the housing 2 and can have a nozzle 21′ arranged radially on the second annular space 21 for connection of a hose or line for further discharge of the fluid.

A further electrically or fluidically actuatable and mechanically acting opening and closing means is provided for discharging an intermediate phase IP. According to FIG. 1, this is designed as an outer—and thus here second—piston slide valve 22 arranged on the outside of the centrifuging drum 1.

This can be advantageously designed as shown below. However, it can also be designed differently.

The outer, second piston slide valve 22 is arranged here below the centrifuging drum 1 on its outer side. The piston slide valve 22 is provided to close or open the discharge openings 25 so that the intermediate phase IP can be discharged from the discharge openings 25. For this purpose, the piston slide valve 22 is movable in the axial direction. For this purpose, the piston slide valve 22 is movably guided in a support ring 22′. In order to be able to move the piston slide valve 22 in the axial direction, the support ring 22′ has lines 27, 28, and possibly an overflow bore 32, which can be supplied with opening or closing fluid as required, which will be described in more detail below.

The discharge of the intermediate phase IP can be effected by means of nozzle-like tubes 23, which are mounted in bores in the inner piston slide valve 12 in a circumferentially distributed manner and the length of which is adapted to reach into the layer of the intermediate phase IP forming during rotation of the centrifuging drum 1, which is characterized by a radius R3. Via corresponding bores 24 extending in axial direction in a wall of the lower drum part 3, the intermediate phase IP reaches at least one, preferably several discharge openings 25 distributed around the circumference of the centrifuging drum 1, which can be closed or opened by the outer piston slide valve 22.

The radius R3 is smaller than a larger radius R2 on which the inlets of the heavy solid matter discharge openings 13 are located, but larger than the radius R1 on which the light liquid phase LP is discharged through the peeling disc 11.

For discharging the intermediate phase IP, a discontinuously operating second discharge device 26 is provided, which comprises the mechanical opening and closing means, which can be fluidically actuated by actuators to perform opening and closing movements.

For this purpose, the second discharge device 26 comprises an injection line 27 for opening fluid and an injection line 28 for closing fluid, to which fluid, in particular water, can be supplied for activating the opening and closing movements via an opening fluid supply line 29 and a closing fluid supply line 30, in which a second opening fluid valve V3 and a second closing fluid valve V4 are arranged.

A plurality of piston valves 31 are provided, each of which serves or is used to provide a controlled discharge of the fluid used to perform the opening and closing movements of the outer piston slide valve 22.

The closing process, i.e., the lifting of the outer piston slide valve 22, is performed here by a closing fluid that is injected into a chamber in the support ring 22′ below the outer piston slide valve 22. The closing fluid is metered via a second closing fluid valve V4. The chamber in the support ring 22′ of the outer piston slide valve 22 optionally has the overflow bore 32, so that the maximum filling quantity of this chamber (and thus the maximum closing force of the outer piston slide valve 22) can be defined. The chamber is in communication with the piston valves 31, which are arranged in a wall of the outer piston slide valve 22 rotating with the centrifuging drum 1 in such a way that they are closed by the centrifugal force prevailing in the centrifuging drum 1 in operation.

The opening process, i.e., the lowering of the outer piston slide valve 22, is performed by an opening fluid that opens the piston valves 31, which in turn allows the closing fluid under the outer piston slide valve 22 to escape from the chamber. The opening fluid is metered through a corresponding second opening fluid valve V3. A third annular space 33 is associated with the discharge openings 25 in the wall of the centrifuging drum 1 for the intermediate phase IP, so that the intermediate phase IP is discharged separately. The third annular space 33 can have a nozzle 33′ arranged radially on the third annular space 33 for connection of a hose or line for further discharge of the intermediate phase IP.

The closing fluid escapes through the piston valves 31 into a fourth annular space 34, which is arranged in the housing 2 and can have a nozzle 34′ arranged radially on the fourth annular space 34 for connection of a hose or line for further discharge of the fluid.

According to FIG. 1, it is advantageously possible—here by means of the second piston slide valve 22—to discharge the intermediate phase IP from the centrifuging drum 1 in a defined manner and with very low loss. Due to the separate, second discharge device 26, which can be actuated independently of the first discharge device 15, the discharge of the intermediate phase IP by the outer piston slide valve 22 is advantageously completely decoupled from the discharge of the solid phase SP by the inner piston slide valve 12. As a result, the intermediate phase IP can be discharged from the centrifuging drum 1 independently of the solid phase SP.

By means of a control unit (not shown here), the actuation of the inner piston slide valve 12 and the actuation of the outer piston slide valve 22 can be controlled independently of each other. The control unit can also be a central control unit for controlling the separator, which, in addition to controlling the two piston slide valves 12, 22, is also provided for other control and/or regulation tasks of the centrifuge.

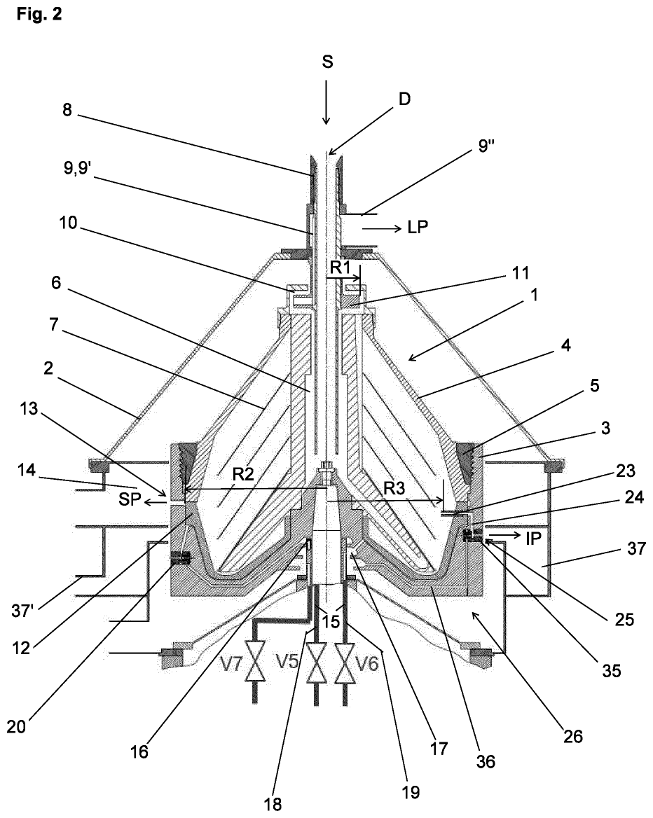

FIG. 2 shows a further separator. The basic design initially corresponds largely to that of the separator shown in FIG. 1. Deviations and/or additions to the embodiment variant of FIG. 1 are especially described below.

According to FIG. 2, the solid phase SP is discharged as in the embodiment variant according to FIG. 1 using an internal piston slide valve 12. A first opening fluid valve V5 is provided here for the supply of opening fluid, and a first closing fluid valve V6 is provided here for the supply of closing fluid.

However, in contrast to the embodiment variant of the centrifuge according to FIG. 1, the embodiment variant of the centrifuge according to FIG. 2 does not have an outer piston slide valve 22.

The discharge of the intermediate phase IP takes place according to the embodiment variant of FIG. 2, again initially through nozzle-like tubes 23, which are mounted in initially radially extending bores in the inner piston slide valve 12, which merge into axial bores 24 in the lower drum part 3 or with which they correspond and the length of which is adapted in such a way that they reach into the layer of the intermediate phase IP forming during rotation of the centrifuging drum 1, characterized by a radius R3. The radius R3 is smaller than the radius R2 on which the solid matter discharge openings 13 are arranged, but larger than the radius R1 on which the liquid phase LP is discharged by the peeling disc 11.

For discharging the intermediate phase IP, a discontinuously actuatable operating second discharge device 26 is provided with a mechanically acting opening and closing means, which here has a plurality of piston valves 35. Via the corresponding bores 24 extending in the axial direction in a wall of the lower drum part 3, the intermediate phase IP reaches a plurality of discharge openings 25 distributed around the circumference of the centrifuging drum 1, each of which can be closed or opened here by one of the piston valves 35. The piston valves 35 can be arranged in the wall of the lower drum part 3 of the centrifuging drum 1 in such a way that the discharge openings 25 are closed by centrifugal force during operation. On the other hand, they can be opened by hydraulic actuation with a control fluid.

The second discharge device 26 further comprises here an opening fluid supply line 36, via which control fluid can be supplied to the piston valves 35. The control fluid can open the piston valves 35 when the intermediate phase IP is to be discharged from the centrifuging drum 1. The opening time of the piston valves 35 can be adjusted by the supply duration of the supplied opening fluid. The opening fluid is metered via a corresponding opening fluid valve V7.

The discharge openings 25 for the intermediate phase IP open here into a second annular space 37, so that both the solid phase SP and the intermediate phase IP can be discharged separately from one another. The annular space 37 is arranged in the housing 2 and can have a nozzle 37′ arranged radially on this annular space 37 for connecting a hose or a line for further discharge of the intermediate phase IP.

Also according to FIG. 2, it is possible—here by means of the hydraulically actuatable piston valves 35—to discharge the intermediate phase IP from the centrifuging drum 1 in a defined manner and with very low losses.

As a result of the separate second discharge device 26, which can be controlled independently of the first discharge device 15, the discharge of the intermediate phase IP through the piston valves 35 can advantageously be completely decoupled from the discharge of the solid phase SP through the inner piston slide valve 12. As a result, the intermediate phase IP can be discharged from the centrifuging drum 1 independently of the solid phase SP.

By means of a control unit (not shown here), the actuation of the inner piston slide valve 12 and the actuation of the actuatable piston valves 35 can be controlled independently of each other. The control unit can also be a central centrifuge control unit which, in addition to controlling the inner piston slide valve and the piston valves 35, is also provided for other control and regulation tasks of the centrifuge.

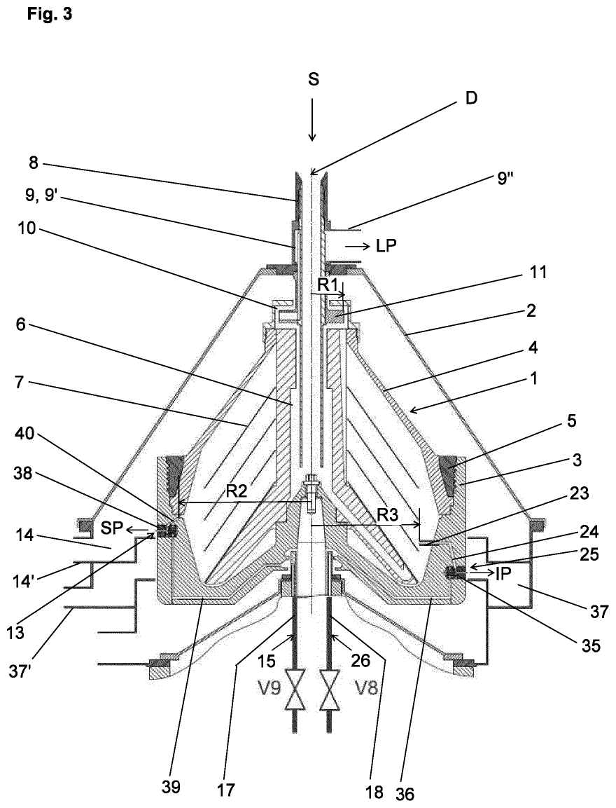

FIG. 3 shows a third centrifugal separator. The basic design initially corresponds largely to that of the separator in FIGS. 1 and 2. In the following, deviations from and/or additions to the design variant in FIGS. 1 and 2 are described in particular.

Deviating from the design variant of the centrifuge according to FIG. 1 or 2, the design variant of the centrifuge according to FIG. 3 has neither an inner piston slide valve 12 nor an outer piston slide valve 22.

In the embodiment variant of the centrifuge according to FIG. 3, the intermediate phase IP is discharged from the centrifuging drum 1 by at least one, preferably several, piston valves 35, which are distributed around the circumference of the centrifuging drum 1—as already described for the embodiment variant according to FIG. 2. The piston valves 35 are here the opening and closing means of the discontinuously operating, second discharge device 26, which serves to discharge the intermediate phase IP from the centrifuging drum 1.

Similarly, the solid phase SP according to FIG. 3 is also discharged from the centrifuging drum 1 by at least one, preferably several, piston valves 38 distributed around the periphery of the centrifuging drum 1. The piston valves 38 are here the opening and closing means of the discontinuously operating, first discharge device 15, which serves to discharge the solid phase SP from the centrifuging drum 1.

Both the solid phase SP and the intermediate phase IP reach the respective piston valves 35, 38, which are mounted at different heights (relative to a bottom of the centrifuging drum 1 or of the lower drum part 3) in the outer wall of the lower drum part 3 of the centrifuging drum 1, via the nozzle-like tubes 23 as well as bores 24 corresponding thereto extending in the axial direction in a wall of the lower drum part 3 or via bores 40 in the wall of the lower drum part 3 of the centrifuging drum 1. The radius R3 on which the inlet opening of the tube 23 for discharging the intermediate phase IP is arranged is smaller than the radius R2 on which the solid matter discharge openings 13 are arranged, but larger than the radius R1 on which the liquid phase LP is discharged by the peeling disc 11.

For fluidic actuation of the respective piston valve 38, the first discharge device 15 comprises an opening fluid supply line 39, via which control fluid can be supplied to the respective piston valve 38. The control fluid can be used to open the respective piston valve 38 when the solid phase SP is to be discharged from the centrifuging drum 1.

For fluidic actuation of the respective piston valve 35, the second discharge device 26 also comprises an opening fluid supply line 36, via which control fluid can be supplied to the respective piston valve 35. The control fluid can be used to open the respective piston valve 35 when the intermediate phase IP is to be discharged from the centrifuging drum 1.

The opening time of the respective piston valves 35, 38 can be adjusted by the duration of the control fluid supplied in each case. The piston valves 35, 38 are each arranged in the wall of the lower drum part 3 of the centrifuging drum 1 in such a way that they are closed by the centrifugal force.

The opening fluid for the piston valves 35, 38 is metered via corresponding opening fluid valves V8, V9, each of which is inserted in opening fluid supply lines 17, 18.

Due to the separate, second discharge device 26, which can be controlled independently of the first discharge device 15, the discharge of the intermediate phase IP through the piston valves 35 is advantageously completely decoupled from the discharge of the solid phase SP through the piston valves 38. As a result, the intermediate phase IP can be discharged from the centrifuging drum 1 independently of the solid phase SP.

The discharge openings 13, 25 arranged at different heights in the wall of the lower drum part 3 for the intermediate phase IP and for the solid phase SP are each assigned annular spaces 37, 14 so that both the solid phase SP and the intermediate phase IP can be discharged separately from one another. The respective annular space 37, 14 has a nozzle 37′, 14′ which is arranged radially on the respective annular space 37, 14. The respective nozzle 37′, 14′ is intended for connection of a hose or line for further discharge of the respective phase.

The valves V1 to V9 of the various embodiments are preferably designed as actuatable valves, in particular as electrically actuatable valves, which can be connected to the control device.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### List of Reference Signs

1 Centrifuging drum
2 Housing
3 Lower drum part
4 Upper drum part
5 Locking ring
6 Distributor
7 Disc pack
8 Inlet pipe
9 Liquid discharge
9′ Annular space
9″ Nozzle
10 Peeling disc chamber
11 Peeling disc
12 Inner piston slide valve
13 Solid matter discharge opening
14 First annular space
14′ Nozzle
15 First discharge device
16 Injection chamber
17 Injection chamber
18 Opening fluid supply line
19 Closing fluid supply line
20 Piston valve
21 Second annular space
21′ Nozzle
22 Outer piston slide valve
22′ Support ring
23 Tube
24 Bore
25 Discharge opening
26 Second discharge device
27 Injection line
28 Injection line
29 Opening fluid supply line
20 Closing fluid supply line
31 Piston valve
32 Overflow bore
33 Third annular space
33′ Nozzle
34 Fourth annular space
34′ Nozzle
35 Piston valve
36 Opening fluid supply line
37 Second annular space
37′ Nozzle
38 Piston valve
39 Opening fluid supply line
40 Bore
D Rotational axis
S Suspension
LP Liquid phase
SP Solid phase
IP Intermediate phase
R1 Radius
R2 Radius
R3 Radius
V1, V5 First opening fluid valve
V2, V6 first closing fluid valve
V3 Second opening fluid valve
V4 Second closing fluid valve
V7 Opening fluid valve
V8 Opening fluid valve
V9 Opening fluid valve

1-21. (canceled)

22. A self-draining separator configured to centrifugally separate a suspension into at least a liquid phase, a solid phase, and an intermediate phase, the self-draining separator comprising:
a centrifuging drum rotatable about a rotational axis and configured so that the suspension to be processed can be introduced into the centrifuging drum;
at least one liquid discharge configured to discharge the light liquid phase;
one or more discontinuously acting solid matter discharge openings configured to discharge the solid phase, wherein a first discontinuously acting discharge device is assigned to the one or more discontinuously acting solid matter discharge openings, and wherein the first discontinuously acting discharge device is configured to discontinuously open and close the one or more discontinuously acting solid matter discharge openings; and
one or more discontinuously acting intermediate phase discharge openings configured to discharge the intermediate phase, wherein a second discontinuously acting discharge device is assigned to the one or more discontinuously acting intermediate phase discharge openings, and wherein the second discontinuously acting discharge device is configured to discontinuously open and close the one or more discontinuously acting intermediate phase discharge openings,
wherein the second discontinuously acting discharge device is actuatable independently of the first discontinuously acting discharge device so that the discharge of the intermediate phase is performed temporally independently of the discharge of the solid phase.

23. The self-draining separator of claim 22, wherein
the first discontinuously acting discharge device comprises at least one hydraulically or electrically actuatable mechanically acting opening and closing means, with which the one or more discontinuously acting solid matter discharge openings are openable and closable, and
the second discontinuously acting discharge device comprises at least one hydraulically or electrically actuatable mechanically acting opening and closing means, with which the one or more discontinuously acting intermediate phase discharge openings are openable and closable.

24. The self-draining separator of claim 23, wherein the hydraulically or electrically actuatable mechanically acting opening and closing means of the first discontinuously acting discharge device is a piston slide valve arranged in or on an outside of the centrifuging drum, wherein the piston slide valve is configured to be hydraulically actuated and movable into different positions to open the one or more discontinuously acting solid matter discharge openings in an open position or to close the one or more discontinuously acting solid matter discharge openings in a closed position.

25. The self-draining separator of claim 23, wherein the electrically or fluidically actuatable mechanically acting opening and closing means of the first discharge device has one or more electrically or fluidically actuatable piston valves, which are assigned to respective ones of the one or more discontinuously acting solid matter discharge openings to open the one or more discontinuously acting solid matter discharge openings or to close the one or more discontinuously acting solid matter discharge openings in a closed position.

26. The self-draining separator of claim 23, wherein the hydraulically or electrically actuatable mechanically acting opening and closing means of the second discharge device is a piston slide valve arranged on an outside of the centrifuging drum and, is hydraulically actuatable to be moved into different positions in order to open the one or more discontinuously acting intermediate phase discharge openings in an open position or to close the one or more discontinuously acting intermediate phase in a closed position.

27. The self-draining separator of claim 23, wherein the hydraulically or electrically actuatable mechanically acting opening and closing means of the second discharge device has one or more electrically or fluidically actuatable piston valves, which are assigned to respective ones of the one or more discontinuously acting intermediate discharge openings to open the one or more discontinuously acting intermediate discharge openings or to close the one or more discontinuously acting intermediate discharge openings in a closed position.

28. The self-draining separator of claim 23, wherein the hydraulically or electrically actuatable mechanically acting opening and closing means of the first discharge device is a piston slide valve arranged in the centrifuging drum and is hydraulically actuatable, and wherein the hydraulically or electrically actuatable mechanically acting opening and closing means of the second discharge device is a further hydraulically actuatable piston slide valve arranged on an outside of the centrifuging drum.

29. The self-draining separator of claim 23, wherein the hydraulically or electrically actuatable mechanically acting opening and closing means of the first discharge device is a piston valve arranged in the centrifuging drum and is hydraulically actuatable, and wherein the hydraulically or electrically actuatable mechanically acting opening and closing means of the second discharge device has hydraulically or electrically actuatable piston valves, which are assigned to respective ones of the one or more discontinuously acting intermediate phase discharge openings in order to open the one or more discontinuously acting intermediate phase discharge openings or to close the one or more discontinuously acting intermediate phase discharge openings in a closed position.

30. The self-draining separator of claim 23, wherein the hydraulically or electrically actuatable mechanically acting opening and closing means of the first discharge device has hydraulically or electrically actuatable piston valves that are assigned to respective ones of the one or more discontinuously acting solid matter discharge openings in order to open the one or more discontinuously acting solid matter discharge openings or to close the one or more discontinuously acting solid matter discharge openings in a closed position, and wherein the hydraulically or electrically actuatable mechanically acting opening and closing means of the second discharge device has further hydraulically or electrically actuatable piston valves that are assigned to respective ones of the one or more discontinuously acting intermediate phase discharge openings in order to open the one or more discontinuously acting intermediate phase discharge openings or to close the one or more discontinuously acting intermediate phase discharge openings in a closed position.

31. The self-draining separator of claim 22, further comprising:
nozzle-like tubes arranged in or at the one or more discontinuously acting intermediate phase discharge openings, wherein a length of the nozzle-like tubes is such that the nozzle-like tubes extend radially up to a radius R3 into a layer of the intermediate phase forming radially in the centrifuging drum during rotation of the centrifuging drum, so that discharge of the intermediate phase from the centrifuging drum occurs on the radius R3.

32. The self-draining separator of claim 31, wherein the nozzle-like tubes are distributed on a circumference of a lower drum part of the centrifuging drum.

33. The self-draining separator of claim 31, wherein the first discontinuously acting discharge device includes a piston slide valve, and wherein the nozzle-like tubes are distributed on a circumference of the piston slide valve.

34. The self-draining separator of claim 31, wherein the radius R3 is smaller than a radius R2 of the centrifuging drum, wherein the one or more discontinuously acting solid matter discharge openings are arranged on the radius R2, wherein the at least one liquid discharge is arranged on a radius R1 of the centrifuging drum, and wherein the radius R3 is larger than the radius R1.

35. The self-draining separator of claim 22, further comprising:
a peeling disc assigned to the at least one liquid discharge.

36. The self-draining separator of claim 22, further comprising:
an inlet pipe; and
a distributor, wherein the suspension to be processed is introducible into the centrifuging drum through the inlet pipe and the distributor.

37. The self-draining separator of claim 22, further comprising:
a first annular space arranged in a hood-like housing and having a nozzle, wherein the nozzle is arranged radially on the first annular space so that a hose or a line for further discharge of the solid phase is connectable to the nozzle, wherein the self-draining separator is configured so that discharged solid phase passes through the one or more discontinuously acting solid matter discharge opening into the first annular space.

38. The self-draining separator of claim 37, further comprising:
a further annular space arranged in the hood-like housing and having a further nozzle, wherein the further nozzle is arranged radially on the first annular space so that a hose or a line for further discharge of the intermediate phase is connectable to the further nozzle, wherein the self-draining separator is configured so that discharged intermediate phase passes through the one or more discontinuously acting intermediate phase discharge opening into the further annular space.

39. A method for operating a self-draining separator comprising a centrifuging drum to centrifugally separate a suspension into at least a liquid phase, a solid phase, and an intermediate phase, the method comprising:
a) introducing the suspension into a centrifugal field of the centrifuging drum through an inlet pipe and a distributor;
b) discharging, via at least one liquid discharge, the liquid phase;
c) discontinuously discharging the solid phase through at least one solid matter discharge opening by controlling a first discharge device to discontinuously open and close the at least one solid matter discharge opening; and
d) discontinuously discharging the intermediate phase through at least one intermediate phase discharge opening by controlling a second discharge device to discontinuously open and close the at least one intermediate phase discharge opening,
wherein the second discharge device is actuatable independently of the first discharge device so that the discharge of the intermediate phase is decoupled from the discharge of the solid phase.

40. The method of claim 39, wherein steps a) to d) run in parallel in time.

41. The method of claim 39, wherein steps c) and d) run periodically or aperiodically.

42. The method of claim 39, wherein steps c) and d) have a different period duration.
